(19) United States
(12) Patent Application Publication
(10) Pub. No.: US 2024/0202755 A1
(43) Pub. Date: Jun. 20, 2024

(54) PROACTIVE PUSH SURVEY SERVICES FOR ENTERPRISE APPLICATIONS

(71) Applicant: SAP SE, Walldorf (DE)

(72) Inventors: Niels HEBLING, Walldorf (DE); Klaus HERTER, Leimen (DE); Martin DAUER, Bad Salzuflen (DE); Anilkumar BAIRI, Wiesloch (DE); Jan HEILER, St. Leon-Rot (DE)

(21) Appl. No.: 18/081,286

(22) Filed: Dec. 14, 2022

(51) Int. Cl. G06Q 30/0203; G06Q 30/0282

(52) U.S. Cl. CPC G06Q 30/0203; G06Q 30/0282

(57) ABSTRACT

Disclosed herein are system, method, and computer program product embodiments for collecting user feedback. An embodiment may operate by receiving a triggering event where the triggering event contains identification data. The triggering event may be validated. A configuration file may be retrieved using at least some of the identification data received as part of the triggering event. A survey may be retrieved associated with the triggering event. The survey may be configured in accordance with the configuration file to generate a configured survey. The configured survey may be transmitted. Responses may be received to the configured survey. The process executed may improve the product or make improvements since they have a better understanding of a user's needs due to the collected results.

### BACKGROUND

Asking users for feedback is a common practice used on public websites, shops, apps, etc. User feedback may help to understand the users' impression, needs, and problems with a product. The value of user feedback is important to understand user needs and be able to react with appropriate improvements and features to the product. (Giving users what they need to efficiently fulfill their tasks allows for a pleasant experience in doing their daily work. Collecting user feedback in software applications such as enterprise resource planning (ERP) systems or similar may be greatly beneficial for developmental teams to evaluate what users desire and/or expect from products and future product improvements.

### BRIEF DESCRIPTION OF THE DRAWINGS

The accompanying drawings are incorporated herein and form a part of the specification.

FIG. 1 is a flowchart for a process in relation to a feedback process, according to some embodiments.

FIG. 2 is an overview of responsibilities and general process flow, according to some embodiments.

FIG. 3 is a flowchart of processing a feedback request, according to some embodiments.

FIG. 4 is a data flow diagram of possibilities to initiate a feedback request, according to some embodiments.

FIG. 5 is an example timeline of a survey being presented to a user, according to some embodiments.

FIG. 6A is a flowchart of in-app push events according to some embodiments.

FIG. 6B is a flowchart of dynamic push events, according to some embodiments.

FIG. 7 is a data flow diagram of an overview of an application sending a feedback request, according to some embodiments.

FIG. 8 is an example method for collecting user feedback in a software application environment, according to some as embodiments.

FIG. 9 is an example computer system useful for implementing various embodiments, according to some embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for collecting user feedback in an environment of a software application in an adequate way using proactive mechanisms.

Software or applications used by employees, or users, in companies are usually required by the employer and the employee has no chance to select a different software or application based on personal choice or preference. The software or application, which may be referred to as a product, is often chosen, as the company believes it is the best option to fulfill the tasks required for a job. Since the product has been chosen already, the user cannot stop using the product and choose a different one.

Due to the requirements of a user using the specific product, this may bring challenges to the user's experience and expectations as to what may or may not be acceptable within the product. Feedback from the user may be provided in multiple ways such as: a first option that the user directly provides feedback in a user interface (UI), or a second option that invites the user to take a feedback survey. In the case of the first option, this may be done by clicking on a UI control, for example as a button, link, icon, etc., to actively initiate giving feedback via survey. The button or link may be in the form of a question mark for example, and would be a manual interaction by the user. The intention in the first option is such to specifically provide feedback. In the case of the second option, the user is invited to a survey or directly presented a survey, for example in a pop-up window, for the user to directly answer and does not require the user to provide an explicit interaction from their side. Additional feedback options may also include a feedback request presented to the user, but sent via an external channel.

The first option often tends to be used to report problems or complain about issues about the product. These reports may often show a higher tendency to have negative feedback. The second option is proactively asking the user without having to wait for the user to actively initiate feedback. In case of the second option, the feedback may not be as negative as the user has not sought out the feedback, but was randomly asked. Additionally, the second option may be controlled to ask for feedback in a very specific setting, environment, or task.

Combining both the first and second options may allow the users to provide feedback at any point in time, while also requesting feedback for certain areas of the product. The feedback provided by the users may allow the product vendors to improve the product or make improvements since they have a better understanding of the user's needs due to the collected feedback.

However, disturbing a user's workflow, which may be in the situation of the case of the second option, may cause the user to be distracted. This may cause unnecessarily negative feedback, which is undesirable, so the second option should be more carefully considered. The feedback may cause a negative impact on the user experience, which may be represented in the feedback result. Therefore, the present disclosure provides solutions of how a software provider may ask users for feedback in a product by minimizing negative impact in the user experience, but still maintaining the possibility to initiate the request for feedback without having the user initiate it explicitly or knowingly.

Survey platforms that provide the survey may react to data events as described, but may also include website navigation, URL changes, search terms, data and time, time spent on a website or when the user tries to leave a website. These features are typical for public websites. However, with enterprise applications (EAs), it may be more different as the software processes or tasks the user should fulfill are more complex. EAs are large software systems designed to operate in a corporate environment and may be complex, but scalable, component-based and distributed systems. This may also result from the questions being asked and when the user is asked for feedback is different when it is a public website versus an enterprise application. These specific tasks normally cannot be identified using mechanisms of existing survey platforms.

Point in time is relevant as a user might be in the middle of a task or process and does not want to be disturbed to provide feedback or take a survey. Existing survey platforms usually define static points in time or react to only external events, such as search terms, URL changes, or time spent on the website. These are static points and not dynamic and do not take into account software processes or the actual task that the user is performing. This is different from the present disclosure, which offers an integrated system that allows reactions to the user interactions within the system. The proposed framework takes into account user behavior and product specific events and not only events from a browser.

Additionally, users of public websites have a choice to visit the website or not, while users of enterprise platforms do not have the choice. This decision-making may add more weight to the user experience, which is key to increase the acceptance of the user and meaningful feedback may be collected.

In order for a software developer to receive feedback regarding a software application from a user or customer using the software application in a useful way, a framework may be created, which allows for the implementation of an application framework that provides features and capabilities to proactively ask users for feedback. The framework may be referred to as a product experience (PX) application-programming interface (API), also referred to as a PX-API. The framework may be natively integrated into an actual product for seamless integration. The seamless integration allows for the product to use product and specific software specific events and tasks that may be used as a trigger point at the start of the feedback process. Additionally, using integration via an API, collecting feedback may be a part of the product and allows for keeping the user experience at a high level.

The PX-API may support different options for allowing to proactively ask users for feedback, how the user feedback was initiated and collected, and how the other metadata may be collected. This allows for a new dimension when evaluating the user feedback as then it is possible to compare the different options and the resulting circumstances where and when the feedback process was initiated.

Using the additional information generated allows for different ideas and approaches to be utilized as to how the user experience may be improved or how more valuable feedback may be collected. Learning over a period of time and constant adaptation, the flexibility of the PX-API allows for integration of a real system and user-driven feedback channel.

The feedback process may be started proactively such that no direct user interaction is necessary by the user nor is it the user's direct intent to give feedback. Specifically, two ways to start the process are available. The first option, which may be referred to as an in-app push, is that a user interaction may start a process, run some logic, or change some data. The primary intent of the user in the first option is to not take a feedback survey or something similar. However, the first option allows at the end of the situation that the user is asked for feedback as certain circumstances are achieved (e.g., a threshold has been reached when changing data, a software process has been finished or was cancelled, etc.). These circumstances allow for user feedback to be specifically requested. The second option, which may be referred to as a dynamic push, which is where some time-related event or similar event may result that the user is asked for feedback. This option does not require any user interaction.

Once the process has been initiated, and is running, it may lead to a feedback survey being shown automatically to the user based on some process which has been running in the background and started at some point.

Integrating the feedback process into a specific product may require interactions from multiple parties. The integration may include different responsibilities such as setting up the feedback process, executing the feedback process, and maintaining the feedback process. The different responsibilities may be separated. In order to integrate the PX-API into a product, the specific product's framework must be modified since each product may use a separate framework and LI technology and or framework. Specifically, when a user starts or logs in to the product, the PX-API may begin with basic parameters to be loaded accurately. Basic parameters may include unit ID, environment ID, tenant ID, and/or config URL.

Unit ID may identify the product. Each product may have a unique ID to describe it. Environment ID may identify the runtime environment. The environment ID may indicate whether the current product is running in a development, test, verification, or production environment. Tenant ID may identify customers who are using the product and if the user belongs to it. Additionally, tenant ID may allow survey results to be able to be filtered, grouped, or compared. Config URL may point to a server with the detailed configuration, which may be loaded. The tenant ID, unit ID, and environment ID may be sent to a server described in the config URL and then returns the matching configuration specific to these parameters. Different products may have different configurations depending on the use of the underlying software from which feedback is sought, such as accounting software having a different configuration file than inventory software. In addition, other configuration files may be used depending on the stage of development of a software application such as initial development, testing or verifying of features.

Productive configuration data may represent the configuration which is retrieved in the production customer system. The configuration that may be loaded may include, but not limited to, the survey URL where the survey should be loaded from, values to tune the dynamic push and the timing of the push, values to configure the in-app push for any trigger implemented, or additional flags to switch off features in the PX-API.

Additionally, the PX-API may provide a basic interconnectivity between the application framework of the product and the PX-API. This interconnectivity allows for providing relevant context information as well as providing simple UI logic, such as showing a dialogue to the user for the feedback survey invite.

The PX-API allows for enterprise applications to use an integrated, in-product feedback process that is more user friendly. The PX-API allows for dynamically reacting to circumstances in the system and the to the user's behaviors and needs. The PX-API may be designed such that it is integrated to be a part of the product. With the integration, especially in the software processes, the user experience of the product is not disrupted.

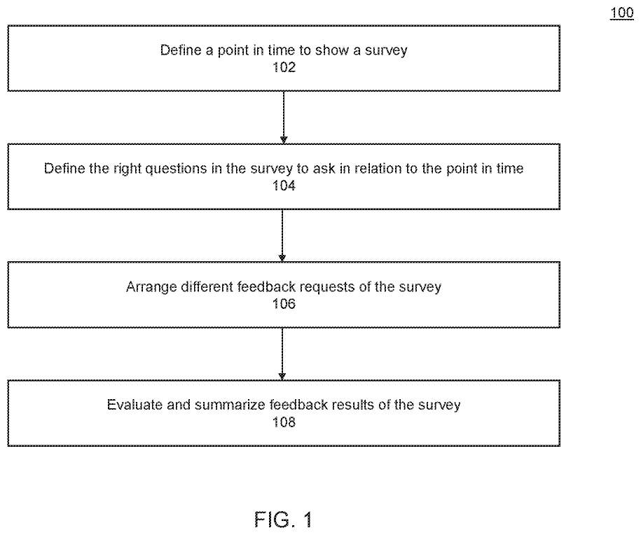

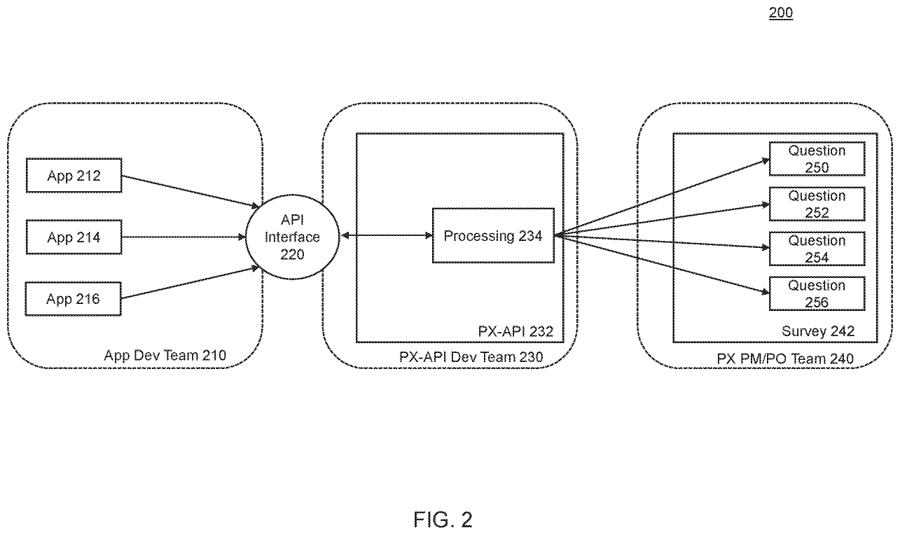

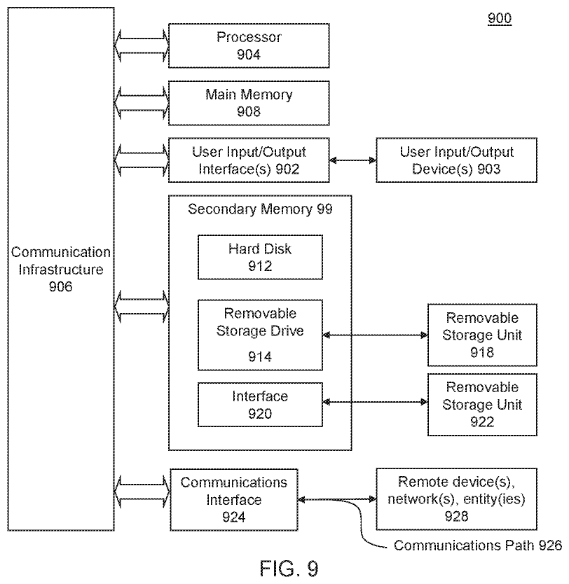

FIG. 1 is a flowchart for a feedback process 100, according to some embodiments. As a convenience and not a limitation, FIG. 1 may be described with regard to elements of FIGS. 2-8. Feedback process 100 may represent the operation of collecting user feedback in an environment of a software application in an adequate way using proactive mechanisms. Feedback process 100 may also be performed by computer system 900 of FIG. 9. However, the feedback process 100 is not limited to the specific aspects depicted in those figures and other systems may be used to perform the method as will be understood by those skilled in the art. It is to be appreciated that not all operations may be needed, and the operations may not be performed in the same order as shown in FIG. 1.

Once the integration of the PX-API has been implemented in a product, the feedback process may be further divided within feedback process 100. Specifically, in 102, a point in time may be defined such that it is appropriate to display a survey and/or ask for feedback from a feedback process perspective and collect such feedback. This point in time definition may be implemented in a product directly or in the underlying framework thereof, depending on the use case. The PX-API is used in the feedback process 100, for example to display the survey or ask for feedback.

In 104, the survey may include the appropriate questions in the survey to ask the user in relation to the previously identified point in time in the business process. The PX PM/PO team, described in FIG. 2, may develop the questions to be used within the survey.

In 106, different feedback requests from the applications of the survey may be arranged. Specifically, the right balance may be arranged of when to allow a feedback request of a survey to be displayed to the user. A feedback request may include, but is not limited to a request for the user to fill out a survey. The PX-API Dev team, described in FIG. 2, may arrange the different feedback requests.

In 108, the feedback results of the survey may be evaluated and summarized in such a way that the data may be visualized. The App Dev team, described in FIG. 2, may evaluate the feedback results. This visualization allows owners or vendors of the product to see the feedback, act appropriately, and implement user feedback into action items for development. This includes metadata collected during the survey. The metadata further provides information data on, for example, how the feedback process was triggered, or how often and what the circumstances were to trigger the feedback survey. The specific circumstances may include, but are not limited to, filter settings, theme, or application versions. In addition to the actual user feedback collected during the survey, the metadata may be considered to interpret the user feedback, but also allowing for the success of a specific trigger and to reiterate and fine-tune the point in time when the feedback process started.

Additionally, the feedback results of the survey may be used for learning of future results. The behavior of the user may be learned and, for example, new push channels may be introduced. The survey may be nm in different modes such as a time control push or infraction application control.

FIG. 2 is an overview of a system and general process flow 200, according to some embodiments. Specifically, the overview shows how the process flow 200 functions and what software elements are responsible for it. As a convenience and not a limitation, FIG. 2 may be described with regard to elements of FIGS. 1 and 3-8. Process flow 200 may represent the operation linking a survey or surveys to a software application under development or being revised. Process flow 200 may also be performed by computer system 900 of FIG. 9. However, the process flow 200 is not limited to the specific aspects depicted in those figures and other systems may be used to perform the method as will be understood by those skilled in the art. It is to be appreciated that not all operations may be needed, and the operations may not be performed in the same order as shown in FIG. 2.

An application development team 210 may be responsible for the different software applications 212, 214, and 216. The application development team 210 can use software development tools to develop new applications as well as provide revisions and updates to existing software applications. Specifically, each software application 212-216 that is developed or revised may include metadata such as an identification code of the software application 212-216 and various trigger names to indicate points in time or during the application process flow where requesting user feedback may be desired, and the data that is included. These trigger names within the application itself can also be called in app pushes because the request for feedback is pushed to the user when the application does something or reaches a particular point in its process flow. This metadata may be extracted from the software applications 212-216 and sent to a public API interface 220. Trigger names may be identified by the application development team 210, the PX-AP development team 230, the PX PM/PO team 240 or any combination of the three for extraction into the public API interface 220.

A PX-API development team 230 may be responsible for processing 234 the metadata from the applications 212-216 from the public API interface 220, which is within a PX-API 232. The public API interface 220 may receive metadata from the applications 212-216.

A PX enablement and application product manager/product owner (PM/PO) team 240 may be responsible for the survey 242. The PX PM/PO team 240 may be responsible for identifying and collecting the requirements and features that an application should provide, and decide what a development team may implement. In addition, the PX PM/PO team 240 may use software to manually or automatically link certain trigger names, as extracted from software applications 212-216, to select questions 250, 252, 254 or 256 to either build an appropriate survey 242 or link an existing survey 242 from a survey provider. By linking a question or questions 250, 252, 254, 256 or a full survey 242 to a trigger name, the appropriate question(s) or survey will be presented to the end user when the end user has a triggering event using one of the software applications 212-216. In some implementations, the survey 242 may include multiple questions 250, 252, 254, 256 that may be presented to the user of the software application 212-216 to solicit feedback. The questions 250-256 may be linked to the applications 212-216 via the trigger name and other metadata for identification purposes. The questions 250-256 may include how the user experience was, how and why did the user use the software application 212-216, or may ask if issues arose from any source at the infrastructure level.

Providing integration into products and their underlying application processes is necessary for developers, architects, or product managers of that specific product as they have the most appropriate domain knowledge to decide when and where in the application process it is acceptable to show a feedback request and survey 242 to a user. This integration into the product is provided by the PX-API 232. Here, the product can be application 212-216. This integration also allows for users and developers, architects, or product managers to see how they interact together as well. For example, a developer may be able to see when a user reaches the end of a workflow and in the survey 242 ask how the experience of the workflow was.

Additionally, the developers, architects, or product managers of the application 212-216 decide a configuration, for example, such as how often a set of questions 250-256 in a survey 242 should be shown to a user and in what time intervals. The set of questions 250-256 may be defined from the point in time when a feedback request is sent, such that the questions 250-256 match the point in time. Additionally, the questions 250-256 provided in the survey 242 must be short and concise as the user might be in an intermediate step of a software process or alternatively, in a situation where a software process may be completed, which allows the survey 242 to be more comprehensive.

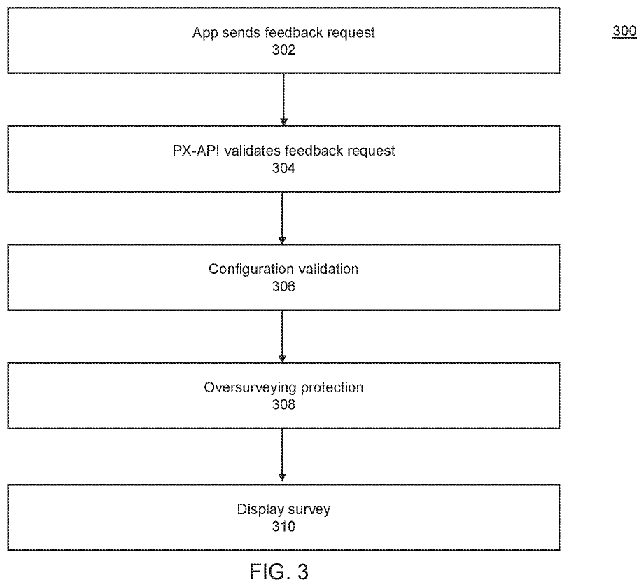

FIG. 3 is a flowchart of processing a feedback request 300, according to some embodiments. As a convenience and not a limitation, FIG. 3 may be described with regard to elements of FIGS. 1-2 and 4-8. The feedback request 300 may represent the operation of collecting user feedback in an environment of a software application in an adequate way using proactive mechanisms. The feedback request 300 may also be performed by computer system 900 of FIG. 9. However, the feedback request 300 is not limited to the specific aspects depicted in those figures and other systems may be used to perform the method as will be understood by those skilled in the art. It is to be appreciated that not all operations may be needed, and the operations may not be performed in the same order as shown in FIG. 3.

In 302, an application sends a feedback request, which has been generated by the PX-API 232. Feedback request is a computer instruction from the software application requesting a question or survey be presented to the end user to solicit his or her feedback about the application. A feedback request may initiate the entire process and may be initiated in at least two ways. In a first way, the feedback request may be initiated by something happening in the software application 212-216. A user interaction, such as a change in the state of a data object or a change in the state of a process may be a triggering event that is used to create a feedback request, for example. In a second way, a triggering event may arise from outside of the confines of software applications 21-216, such as browser events, or based on a timer with a specified interval. Events may include that the theme changed, application-to-application navigation was performed, etc. Additional events may include changes in an application framework or a UI framework done at the infrastructure level. These triggering events are sometimes called dynamic push events as the request for feedback is pushed to the user independently of the application (e.g., lapse of a period of time). The client device being used in conjunction with executing the software application 212, 214 or 216, perhaps a web browser, or an application framework or UI framework will transmit the trigger name and associated other data to the PX-API 232 (or equivalent shown in other figures).

In 304, the PX-API validates the received feedback request. The validation may validate metadata that is provided. The trigger name may also be checked to determine that it is valid. Further validation may occur for example, of the format being used, such as a number is expected that is not a text or text that is too long. If the feedback request is improper and a product ID does not match, then a survey or set of questions soliciting feedback cannot be sent to the user.

If the feedback request is valid, then in 306, the configuration file is applied. Specifically, it is determined whether or not the threshold values have been met. Some examples of configuration include dynamic timing feedback (e.g., how often a set of questions has been used relative to the threshold set in the configuration file), which may not be specific to the application, duration of time spent in the application, rules of time, whether it's worth sending the survey to the user, and efficiency of the workflow.

In 308, it is determined if oversurveying is enabled. Preventing oversurveying is a feature that may prevent too many surveys from being shown to a single user in too short of a timeframe. Specifically, if a survey is shown every few minutes or every hour to a given user, the user may become annoyed or frustrated quickly. The preventing oversurveying feature is provided to avoid that frustration.

Thresholds to control oversurveying include defining a certain time period, such as a timeframe of x days where no surveys are allowed. Once a user has seen or taken the survey, this specific user will not presented with another survey for that defined time period. This protection may also apply if the user has been invited to take the survey, but always dismissed the survey. After a specified number of dismissals by the user, the user will automatically be blocked from any further survey or invitation dialog to be shown during the above mentioned time period. In this manner, the user has established their own threshold to avoid oversurveying (e.g., a threshold of 0).

If a time period for not sending surveys has been established and that time period has expired, the PX-API will again allow surveys to be shown to the user. This can allow the user to always have a specific time period without being presented with the survey. The feedback request may still be sent to the PX-API, but may be blocked if the time period has not passed.

The thresholds may define the time periods, especially for the period between two dynamic push triggered requests, between two in-app push request, or the time period between a dynamic push request and an in app push request. Additionally, there is also a setting to define the time period which needs to pass before an invitation dialog to provide feedback may be shown again to the user after they delay interacting with the request for feedback. This means that the invitation dialog for providing feedback is “snoozed” for some time before another invitation dialog is allowed to be displayed to the user.

In 310, the survey may be displayed to the user. The displaying of the survey may be in any form including a pop-up box or opening another window while shrinking the window in which the application is being displayed.

A feedback request may contain basic information to identify the feedback request itself by using an identifier and may also contain further information. The further information may include text to refer to the environment that the feedback request was initiated in or may include data that was within the feedback result that supports understanding the environment the user was working in at that point in time.

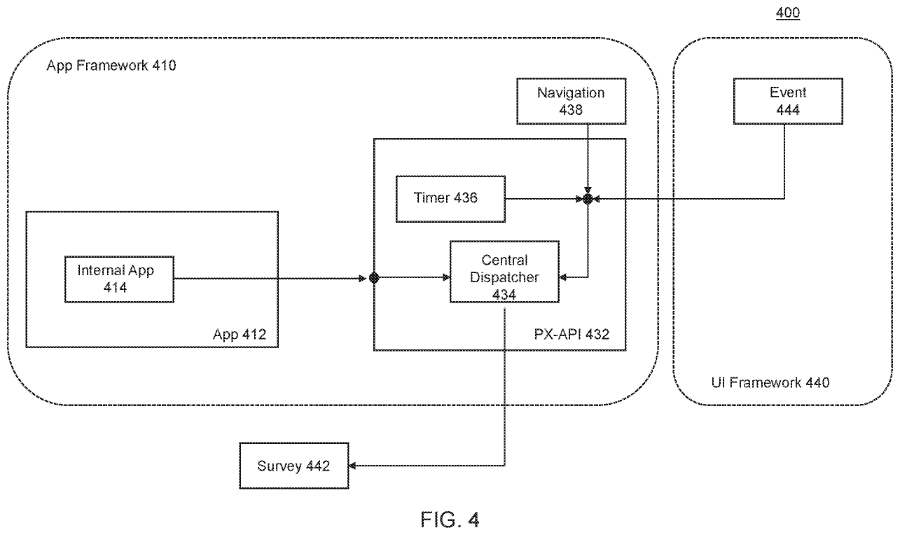

FIG. 4 is a data flow diagram 400 of the overview of possibilities to initiate a feedback request, according to some embodiments. As a convenience and not a limitation, FIG. 4 may be described with regard to elements of FIGS. 1-3 and 5-8. The data flow diagram 400 may represent the operation of initiating a feedback request in an environment of a software application in an adequate way using proactive mechanisms. The data flow diagram 400 may also be performed by computer system 900 of FIG. 9. However, the data flow diagram 400 is not limited to the specific aspects depicted in those figures and other systems may be used to perform the method as will be understood by those skilled in the art. It is to be appreciated that not all operations may be needed, and the operations may not be performed in the same order as shown in FIG. 4.

A central dispatcher 434 within the PX-API 432 may act as a feedback dispatcher and is a central instance in the overall data flow diagram 400. The central dispatcher 434 may receive events or triggers such as internal app 414, timer 436, application-to-application navigation 438, or specific event 444 and then processes them in the order they arrive. Once received, a survey 442 may be presented. The survey 442 may be shown or presented to the user based on a specific UI related event 444 or if an application-to-application navigation 438 has been performed or a timer 436 has expired or an event 444 sent by any internal app 414 running in the app framework 410 of the product. Application-to-application navigation 438 may be processed in the PX-API 432. As these events 414, 436, 438 and 444 occur, a trigger may be sent from the application, timer, change in UI status or equivalent, to the central dispatcher 434. In addition to data identifying the type of event or trigger, additional data is sent to central dispatcher 434 and may include data such as unit ID, environment ID, tenant ID, configuration URL, or similar. The combination of trigger data along with any identifying data, such as those listed previously, may be used to retrieve the appropriate survey 442 from a data storage unit.

The survey 442 may be sent to the central dispatcher 434 using an event-based mechanism or directly via an API function call from the internal app 414. The order of actions may occur as follows: an event 444 may be initiated, then sent to the central dispatcher 434, and then the survey 442 is shown. An event 444, also referred to as a trigger, may include, but is not limited to a theme being changed, application-to-application navigation 438 being performed, etc. Additionally, a timer 436 may function as to when a survey 442 is sent. The internal app 414 includes internal logic or user interaction to initiate the feedback request. The internal app 414 is within the application 412, which resides in the application framework 410.

Once the survey 442 has been received, the central dispatcher 434 takes the survey 442 for further processing. To process the survey 442, at least three steps, performed in the PX-API 432, are necessary: validation, balancing, and presentation.

An example of initiating a survey 442 may be as follows. An update to a system, such as an application 412 is performed automatically. A user logins to the application 412 and sees the update, which may be for example, a new UI or a new functionality for the user. At the system level, the central dispatcher 434 sends a survey 442 to the user to ask them questions about the update that was performed.

### Validation

The validation step requires validating a feedback request, also referred to as requesting a survey to be forwarded and filled out by a user, against some criteria, which may be provided in advance. Each feedback request may have been submitted with an identifier that allows the validation to fetch some additional validation data that matches the identifier. The feedback request contains pieces of ID data that may be used to query a datastore and retrieve the corresponding validation file. The validation file contains data indicating if feedback is still being sought for this particular trigger in this particular software application. This may be useful if the development team has already received a sufficient amount of user feedback that collecting any additional user feedback past a certain point is not helpful to the development team, but might be viewed as counterproductive to the end user. In such circumstances, the validation data prevents the requesting of feedback from all users, or a specific set of users, after a certain point is reached.

In addition, older versions of software may also be placed on an obsolete list such that collecting any additional feedback regarding the obsolete software isn't warranted. In such cases, the validation step determines that there is no basis to collect additional feedback regarding this particular piece of software. The obsolete list would be part of the validation file to indicate no need to collect additional user feedback.

In other implementations, this step may retrieve some of the associated configuration data with the corresponding triggering event. This configuration data may be provided in advance, may contain various information. In one such implementation, the various configuration data may include information about the maximum number of times the feedback request may be presented or may define a specific frequency in which a feedback request with this identifier may be processed.

Various configuration values may be possible. Once the feedback request has passed the validation successfully, it is passed over to the next step of balancing. However, if the validation has not been successful, it will be dismissed. A feedback request is considered as unsuccessful when, for example, the number of times the feedback request has already resulted in a survey 442 presented to the user is reached.

### Balancing

While the validation step looks at the validation file and configuration data from the perspective of the entity collecting the user feedback. This perspective is established by what is contained in the validation file and configuration data. As noted above, if the request for feedback has been validated, the process continues to the balancing step. The balancing step checks to see if there may be various feedback requests with different frequencies coming from different sources.

The user should be protected from being overloaded with too many surveys in a specified timeframe. This can also be referred to as oversurveying. Using the balancing step, every feedback request must pass through the central dispatcher 434 as a funnel. The central dispatcher 434 controls the number of surveys that may be presented to a single user over time. This step differs from the validation step in that while the validation step is mainly concerned with receiving feedback from a particular triggering event, the balancing step has the perspective of a single individual user. A single user should not be asked to respond to a survey or provide feedback from event 414, timer 436, navigation 438 or event 444 in a relatively short period of time.

The timeframes that may be considered may be independent of the type of feedback request or the actual identifier. All feedback requests should be treated the same and the timeframes that may be considered include: how much time has passed since the last survey was displayed to the user (regardless of the type of triggering event) and how much time has passed since the user decided to skip a survey and be asked to do the survey at a later point in time.

The thresholds for these timeframes may be preconfigured. However, there may also be occurrences when an exception is configured to bypass the balancing and enforce the feedback request to pass the balancing step. Once a feedback request has successfully passed the balancing step, the feedback request will proceed to the presentation step.

### Presentation

Once the feedback request has passed the validation and balancing steps successfully, the feedback request may be handled in at least two different ways. The first is to create a survey invitation. The survey invitation offers the user the option to decide whether to take the survey or to skip the survey for now. By skipping the survey, the user may postpone the survey to be taken at a later point in time. The second way to handle a feedback request is to directly display the survey to the user and directly present the questions to the user.

The implementation of the feedback request may be highly dependent on the UI framework used by the product, which may be software or an application. Additionally, the way the product may visualized the required UI elements for the survey may be different for different products. Specifically, the type of dialogue box that represents a survey invitation versus a notification that invites the user may look different in different products.

The central dispatcher 434 contains or retrieves configuration information that is required to properly display either the invitation to take the survey or the survey itself. The configuration information may be specific to the type of product being used. Central dispatcher 434 will use this configuration data to format the invitation or survey properly before forwarding it to the end user device, which in turn will display the invitation or survey to the end user.

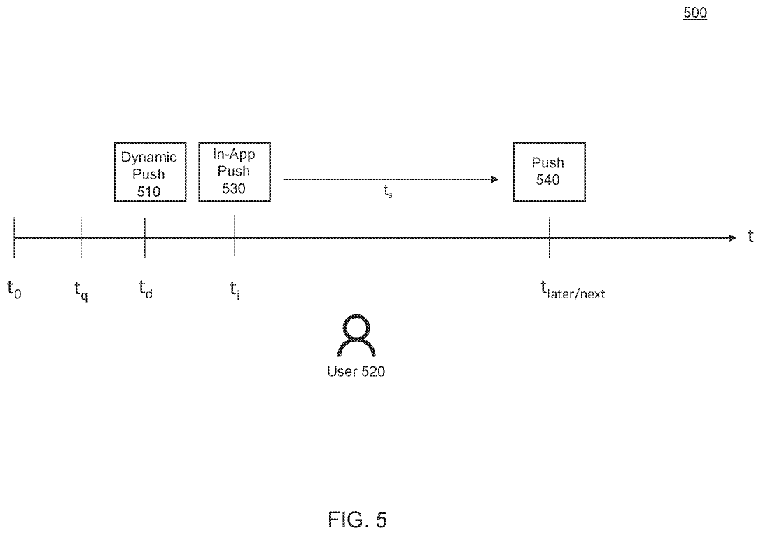

FIG. 5 is an example timeline 500 of an invitation or a survey being presented to a user, according to some embodiments. As a convenience and not a limitation, FIG. 5 may be described with regard to elements of FIGS. 1-4 and 6-9. Timeline 500 may represent the operation of the timeline 500 of a user receiving an invitation for a survey in an environment of a software application in an adequate way using proactive mechanisms. Timeline 500 may also be performed by computer system 900 of FIG. 9. However, the timeline 500 is not limited to the specific aspects depicted in those figures and other systems may be used to perform the method as will be understood by those skilled in the art. It is to be appreciated that not all operations may be needed, and the operations may not be performed in the same order as shown in FIG. 5.

The overview of the timeline 500 is shown on a timescale t. At t₀, a user 520 may login to an application. Since the user 520 recently logged in, a quiet period, t_{q}, is provided in which no invitations or surveys will be presented to the user. In one implementation, any received triggering events may be ignored altogether. In alternative implementations, the triggering events may be stored and simply delayed until after the quiet period t_{q} has expired.

After a period of time t_{d}, there is a possibility of a dynamic push event 510 or after a period of tᵢ, there is a possibility of an in-app push event 530. The user 520 may either take the survey or snooze the survey, such that the survey returns after a period of time tₛ. Once the period of time tₛ passes, the user will receive another push 540 of the survey. The push 540 is at a period of time t_{later/next}. The push 540 may be either the dynamic push event 510 or the in-app push event 530. The periods of time where no survey is pushed may be referred to as a quiet period t_{q}. A quiet period t_{q} is a time frame that may be defined upfront or calculated dynamically based on user behavior based actions.

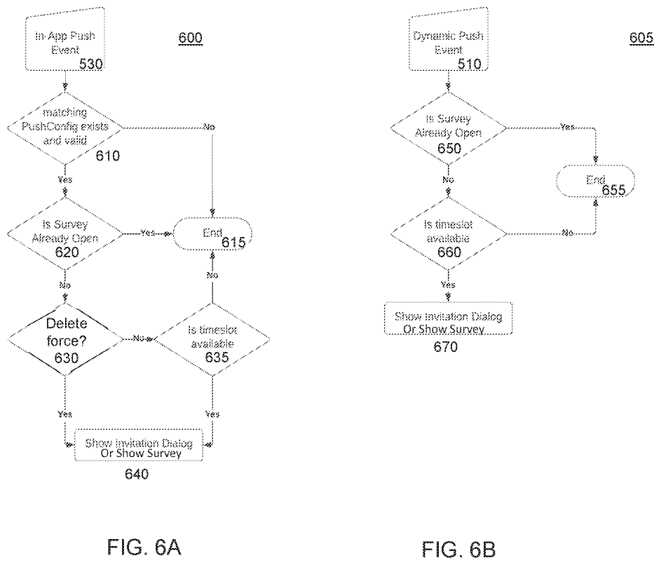

FIG. 6A is a flowchart 600 of in-app push events 530, according to some embodiments. As a convenience and not a limitation, FIG. 6A may be described with regard to elements of FIGS. 1-5 and 7-8. Flowchart 600 may represent the operation of push events in an environment of a software application in an adequate way using proactive mechanisms. Flowchart 600 may also be performed by computer system 900 of FIG. 9. However, the flowchart 600 is not limited to the specific aspects depicted in those figures and other systems may be used to perform the method as will be understood by those skilled in the art. It is to be appreciated that not all operations may be needed, and the operations may not be performed in the same order as shown in FIG. 6A.

As mentioned in FIG. 5, a user 520 may get either an in-app push event 530 or a dynamic push event 510 of receiving a survey, also known as a feedback request.

When an in-app push event 530 occurs, it is determined whether matching a push configuration file is still valid, in 610. If the configuration file does not exist (i.e., it has been deleted after having received sufficient feedback responses) then it is no longer a valid configuration file then the feedback request ends in 615. If the configuration file exists and is valid, then the process proceeds to 620. In 620, it is determined if any survey is already open. An open survey is one in which the user is currently being presented with the questions. Prompting the user with simultaneous surveys should be avoided. If any survey is already open, then the process ends in 615. If the survey is not open, then in 630, it is determined if the immediate push is enabled. An immediate push is determined when the triggering event is received during a quiet period and other criteria, excluding the quiet period, are met to allow the invitation or the survey to be pushed to the end user immediately. In other implementations, step 630 can be replaced with a determination if a quiet period has expired. If it is determined in step 630 that any quiet period t_{q} has expired, then the process proceeds to step 640. In 630, if the immediate push is enabled, or the quiet period t_{q} has expired, then the process proceeds to 640 and an invitation dialogue box to participate in the survey or the actual survey itself is shown to the user.

In 630, if the immediate push is not enabled, or the user is in a quiet period t_{q}, then in 635, it is determined if a future timeslot is available to present the invitation dialogue box or the survey itself. The next available timeslot is determined after the current quiet time t_{q} period expires as well as if other surveys are in the queue for presenting to the user. In 635, if a timeslot is available, the process proceeds to 640 and an invitation dialogue or the survey itself is shown to the user to take the survey. In 635, if a timeslot is not available, for example, there are several intervening surveys such that presenting this survey to the user will occur too late or be viewed as presenting too many surveys, then the process ends in 615. Once presented to the user, the user may decide whether to take or dismiss the survey.

FIG. 6B is a flowchart 605 of in-app push events 510, according to some embodiments. As a convenience and not a limitation, FIG. 6B may be described with regard to elements of FIGS. 1-5 and 7-8. Flowchart 605 may represent the operation of push events in an environment of a software application in an adequate way using proactive mechanisms. Flowchart 605 may also be performed by computer system 900 of FIG. 9. However, the flowchart 605 is not limited to the specific aspects depicted in those figures and other systems may be used to perform the method as will be understood by those skilled in the art. It is to be appreciated that not all operations may be needed, and the operations may not be performed in the same order as shown in FIG. 6B. When a dynamic push event 510 occurs, it is determined in 650 if any survey is already open. In 650, if any survey is not open, then it is determined in 660 if the timeslot is available. In 660, if the timeslot is available, the process proceeds to 670 and an invitation dialogue or the survey itself is shown to the user. In 660, if the timeslot is not available, the process ends in 665. In 650, if any survey is already open, the process then ends in 665.

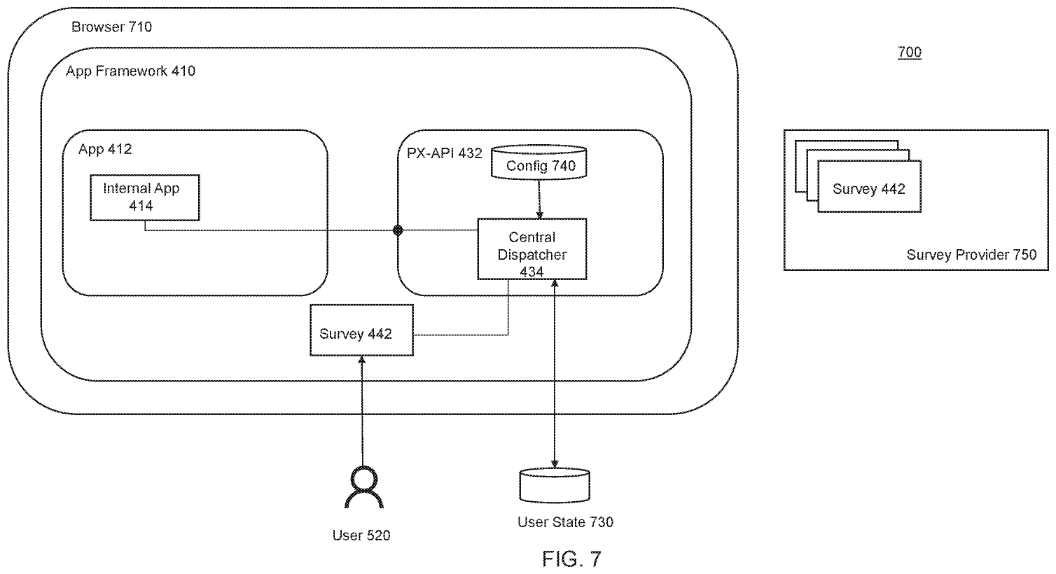

FIG. 7 is a data flow diagram 700 of an overview of an application sending a feedback request, according to some embodiments. As a convenience and not a limitation, FIG. 7 may be described with regard to elements of FIGS. 1-6 and 8. Data flow diagram 700 may represent the operation of sending a feedback request in an environment of a software application in an adequate way using proactive mechanisms. Data flow diagram 700 may also be performed by computer system 900 of FIG. 9. However, the data flow diagram 700 is not limited to the specific aspects depicted in those figures and other systems may be used to perform the method as will be understood by those skilled in the art. It is to be appreciated that not all operations may be needed, and the operations may not be performed in the same order as shown in FIG. 7.

A survey provider 750 may provide surveys 442. The survey 442 may be shown to a user 520. A user 520 may be working in an application 412, which is in an application frame work 410 that may be functioning within a browser 710. The application 412 has an internal app 414 that communicates with a PX-API 432. In the PX-API 432 is a configuration file 740 that is directly input into a central dispatcher 434. The state that the user is working in, referred to as the user state 730, may be read and written by to the central dispatcher 434, which then triggers the survey 442 to be displayed to the user 520.

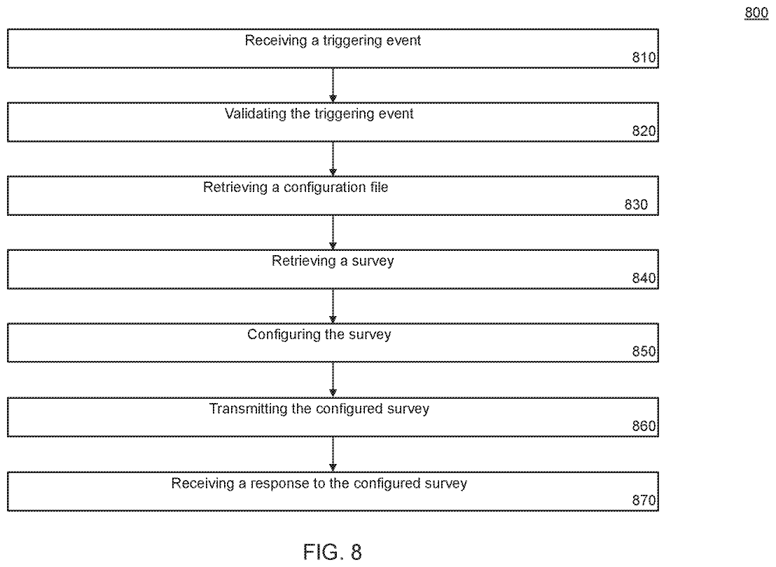

FIG. 8 is an example method 800 for collecting user feedback in an environment of a software application, according to some as embodiments. As a convenience and not a limitation, FIG. 8 may be described with regard to elements of FIGS. 1-7. Method 800 may represent the operation of collecting user feedback in an environment of a software application in an adequate way using proactive mechanisms. Method 800 may also be performed by computer system 900 of FIG. 9. However, the method 800 is not limited to the specific aspects depicted in those figures and other systems may be used to perform the method as will be understood by those skilled in the art. It is to be appreciated that not all operations may be needed, and the operations may not be performed in the same order as shown in FIG. 8.

In 810, a triggering event may be received. The triggering may contain identification data. The triggering event may be a change in an application framework or user interface framework, an internal application event, a timer event, or a web navigation event. The triggering events may be based on user interface event comprising either a product being used at a predetermined point in time or a task performed in the product being used. The product may be software, an application, or enterprise software. In 820, the triggering event may be validated.

In 830, a configuration file may be retrieved using at least some of the identification data received as a part of the triggering event.

In 840, the survey associated with the triggering event may be retrieved. This is typically done by a UI where the end user reads a question presented and provides an answer. The answer may be of the type of true/false, multiple choice or short answer where the user types in sentences to provide feedback.

In 850, the survey may be configured in accordance with the configuration file to generate a configured survey.

In 860, the configured survey may be transmitted.

In 870, a response to the configured survey may be received. The response may include short answer responses that include challenges to a user's experience and expectations as to what may or may not be acceptable within the product.

The feedback request may also be dismissed. When the feedback request is dismissed, a different point in time for the feedback request to be displayed may be suggested. When the different point in time for the feedback request is unavailable, the feedback request may close. If closed, the user will not see a predefined survey. If the different point time is suggested, the user will see the predefined survey at a later time.

FIG. 9 is an example computer system useful for implementing various embodiments, according to some embodiments.

Various embodiments may be implemented, for example, using one or more well-known computer systems, such as computer system 900 shown in FIG. 9. One or more computer systems 900 may be used, for example, to implement any of the embodiments discussed herein, as well as combinations and sub-combinations thereof.

Computer system 900 may include one or more processors (also called central processing units, or CPUs), such as a processor 904. Processor 904 may be connected to a communication infrastructure or bus 906.

Computer system 900 may also include user input/output device(s) 903, such as monitors, keyboards, pointing devices, etc., which may communicate with communication infrastructure 906 through user input/output interface(s) 902.

One or more of processors 904 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 900 may also include a main or primary memory 908, such as random access memory (RAM). Main memory 908 may include one or more levels of cache. Main memory 908 may have stored therein control logic (i.e., computer software) and/or data.

Computer system 900 may also include one or more secondary storage devices or memory 910. Secondary memory 910 may include, for example, a hard disk drive 912 and/or a removable storage device or drive 914. Removable storage drive 914 may be a floppy disk drive, a magnetic tape drive, a compact disk drive, an optical storage device, tape backup device, and/or any other storage device/drive.

Removable storage drive 914 may interact with a removable storage unit 918. Removable storage unit 918 may include a computer usable or readable storage device having stored thereon computer software (control logic) and/or data. Removable storage unit 918 may be a floppy disk, magnetic tape, compact disk, DVD, optical storage disk, and/any other computer data storage device. Removable storage drive 914 may read from and/or write to removable storage unit 918.

Secondary memory 910 may include other means, devices, components, instrumentalities or other approaches for allowing computer programs and/or other instructions and/or data to be accessed by computer system 900. Such means, devices, components, instrumentalities or other approaches may include, for example, a removable storage unit 922 and an interface 920. Examples of the removable storage unit 922 and the interface 920 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 900 may further include a communication or network interface 924. Communication interface 924 may enable computer system 900 to communicate and interact with any combination of external devices, external networks, external entities, etc. (individually and collectively referenced by reference number 928). For example, communication interface 924 may allow computer system 900 to communicate with external or remote devices 928 over communications path 926, which may be wired and/or wireless (or a combination thereof), and which may include any combination of LANs, WANs, the Internet, etc. Control logic and/or data may be transmitted to and from computer system 900 via communication path 926.

Computer system 900 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 900 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 900 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 900, main memory 908, secondary memory 910, and removable storage units 918 and 922, as well as tangible articles of manufacture embodying any combination of the foregoing. Such control logic, when executed by one or more data processing devices (such as computer system 900), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 9. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer implemented method for collecting user feedback, comprising:
receiving a triggering event, wherein the triggering event contains identification data;
validating the triggering event;
retrieving a configuration file using at least some of the identification data received as a part of the triggering event;
retrieving a survey associated with the triggering event;
configuring the survey in accordance with the configuration file to generate a configured survey;
transmitting the configured survey; and
receiving a response to the configured survey.

2. The method of claim 1, further comprising:
dismissing the configured survey; and
suggesting a different point in time for transmitting the configured survey.

3. The method of claim 1, wherein the triggering event is a change in an application framework or user interface framework.

4. The method of claim 1, wherein the triggering event is an internal application event.

5. The method of claim 1, wherein the triggering event is a timer event.

6. The method of claim 1, wherein the triggering event is a web navigation event.

7. The method of claim 1, wherein the triggering event is based on a user interface event comprising either a product being used at a predetermined point in time or a task performed in the product being used.

8. A system, comprising:
a memory; and
at least one processor coupled to the memory and configured to:
receive a triggering event, wherein the triggering event contains identification data;
validate the triggering event;
retrieve a configuration file using at least some of the identification data received as a part of the triggering event;
retrieve a survey associated with the triggering event;
configure the survey in accordance with the configuration file to generate a configured survey;
transmit the configured survey; and
receive a response to the configured survey.

9. The system of claim 8, the at least one processor further configured to:
dismiss the configured survey; and
suggest a different point in time to transmit the configured survey.

10. The system of claim 8, wherein the triggering event is a change in an application framework or user interface framework.

11. The system of claim 8, wherein the triggering event is an internal application event.

12. The system of claim 8, wherein the triggering event is a timer event.

13. The system of claim 8, wherein the triggering event is a web navigation event.

14. The system of claim 8, wherein the triggering event is based on a user interface event comprising either a product being used at a predetermined point in time or a task performed in the product being used.

15. A non-transitory computer-readable device having instructions stored thereon that, when executed by at least one computing device, cause the at least one computing device to perform operations comprising:
receiving a triggering event, wherein the triggering event contains identification data;
validating the triggering event,
retrieving a configuration file using at least some of the identification data received as a part of the triggering event;
retrieving a survey associated with the triggering event;
configuring the survey in accordance with the configuration file to generate a configured survey;
transmitting the configured survey; and
receiving response to the configured survey.

16. The non-transitory computer-readable device of claim 15, the operations further comprising:
dismissing the configured survey; and
suggesting a different point in time for transmitting the configured survey.

17. The non-transitory computer-readable device of claim 15, wherein the triggering event is a change in an application framework or user interface framework.

18. The non-transitory computer-readable device of claim 15, wherein the triggering event is an internal application event.

19. The non-transitory computer-readable device of claim 15, wherein the triggering event is a timer event.

20. The non-transitory computer-readable device of claim 15, wherein the triggering event is a web navigation event.
